(19) United States
(12) Patent Application Publication
(10) Pub. No.: US 2014/0033719 A1
(43) Pub. Date: Feb. 6, 2014

(54) MULTI-STEP COMBUSTOR

(71) Applicants: Rahul Ravindra Kulkarni, Bangalore (IN); Shreenivansan Obla Jayaprakash, Bangalore (IN)

(72) Inventors: Rahul Ravindra Kulkarni, Bangalore (IN); Shreenivansan Obla Jayaprakash, Bangalore (IN)

(21) Appl. No.: 13/564,808

(22) Filed: Aug. 2, 2012

(51) Int. Cl. F02C 7/24; F23R 3/28

(52) U.S. Cl. 60/725; 60/737; 60/746; 60/776

(57) ABSTRACT

The present application provides a combustor for use with a gas turbine engine. The combustor may include a number of fuel nozzles and a combustion zone downstream of the fuel nozzles. The combustion zone may include a number of steps such that the combustion zone expands in a radial direction downstream of the fuel nozzles.

### TECHNICAL FIELD

The present application and the resultant patent relate to gas turbine engines and more particularly relate to a multi-step combustor with a number of pilot fuel/air lines so as to mitigate vortex driven combustion instabilities for reduced emission levels and increased power output.

### BACKGROUND OF THE INVENTION

Operational efficiency and output of a gas turbine engine increases with increases in the temperature of the hot combustion gases. High combustion gas temperatures, however, may produce high levels of nitrogen oxides (NOₓ) and other types of regulated emissions. A balancing act thus exists between operating a gas turbine engine in an efficient temperature range while also ensuring that the output of nitrogen oxides and other types of regulated emissions remain below mandated levels.

Lean premixing tends to reduce combustion temperatures and the output of nitrogen oxides. A gas turbine engine thus may be operated in a lean premixed regime to achieve lower emission levels of nitrogen oxides. Lean premixed combustors, however, may be more susceptible to combustion instabilities due to pressure oscillations in the combustion chamber. Such instabilities may cause undesirable acoustic noise, reduce engine performance and reliability, and/or increase the frequency of required service. Flow coherent structures may play a critical role in driving low frequency combustion instabilities. The flow structures or vortices may be formed by the interaction between sheer flow instabilities and the acoustic resonance of the chamber. When these vortices dominate the reacting flow, the coherent flow structures may lead to periodic heat release and may result in high amplitude pressure oscillations. High levels of combustion dynamics thus may limit the operability envelope of the combustor in terms of emissions and/or power output.

There is thus a need for an improved combustor design so as to limit the impact of low frequency combustion instabilities. Mitigating and controlling such dynamics should improve overall mixing and flame stability for improved emissions and power output. Moreover, the operating life of the combustor and the overall gas turbine may be improved.

### SUMMARY OF THE INVENTION

The present application and the resultant patent thus provide a combustor for use with a gas turbine engine. The combustor may include a number of fuel nozzles and a combustion zone downstream of the fuel nozzles. The combustion zone may include a number of steps such that the combustion zone expands in a radial direction downstream of the fuel nozzles.

The present application and the resultant patent further provide a method of limiting combustion instabilities in a combustor. The method may include the steps of introducing a fuel/air mixture into a multi-step combustion zone, introducing a pilot fuel/air mixture into the multi-step combustion zone, and altering an equivalence ratio of the fuel/air mixture.

The present application and the resultant patent further provide a combustor for use with a gas turbine engine. The combustor may include a number of fuel nozzles and a combustion zone downstream of the fuel nozzles. The combustion zone may include a number of steps such that the combustion zone expands in a radial direction and a number of pilot fuel/air lines therein.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, and a turbine.

FIG. 2 is a schematic diagram of a combustor as may be used with the gas turbine engine of FIG. 1.

FIG. 3 is a schematic diagram of a combustion zone of the combustor of FIG. 2.

FIG. 4 is a schematic diagram of a portion of a multi-step combustor as may be described herein.

FIG. 5 is a schematic diagram of an alternative embodiment of a portion of a multi-step combustor as may be described herein.

### DETAILED DESCRIPTION

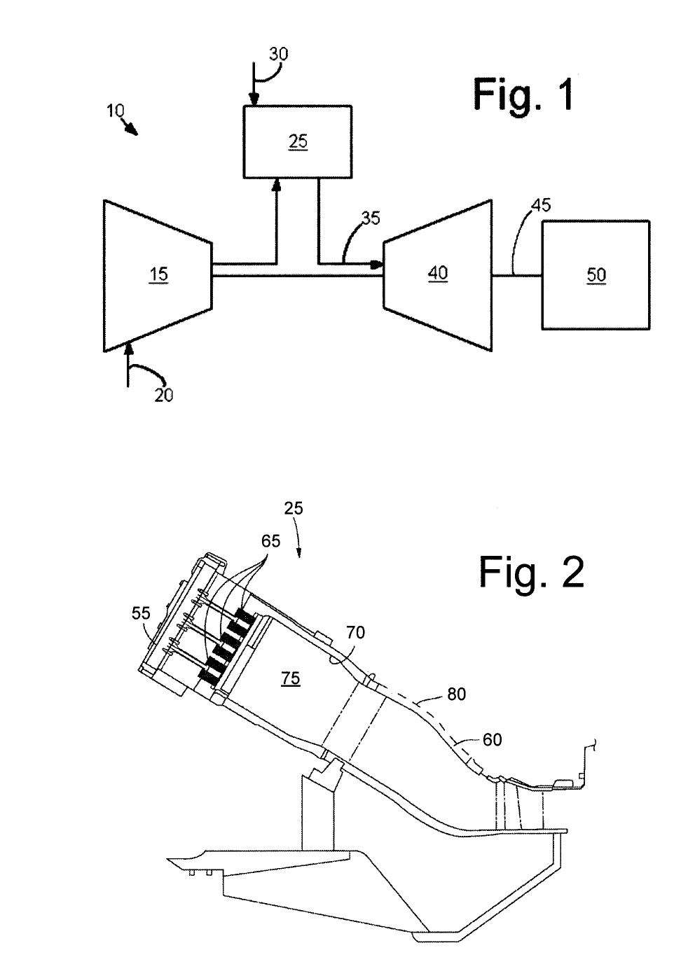

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of the combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines offered by General Electric Company of Schenectady, New York, including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 is a schematic diagram of an example of the combustor 25 as may be used with the gas turbine engine 10 described above. The combustor 25 may extend from an end cap 55 at a head end to a transition piece 60 at an aft end about the turbine 40. A number of fuel nozzles 65 may be positioned about the end cap 55. A liner 70 may extend from the fuel nozzles 65 towards the transition piece 60 and may define a combustion zone 75 therein. The liner 70 may be surrounded by a flow sleeve 80. The liner 70 and the flow sleeve 80 may define a flow path therebetween for the flow of air 20 from the compressor 15 or otherwise. The combustor 25 described herein is for the purpose of example only. Combustors with other components and other configurations may be used herein.

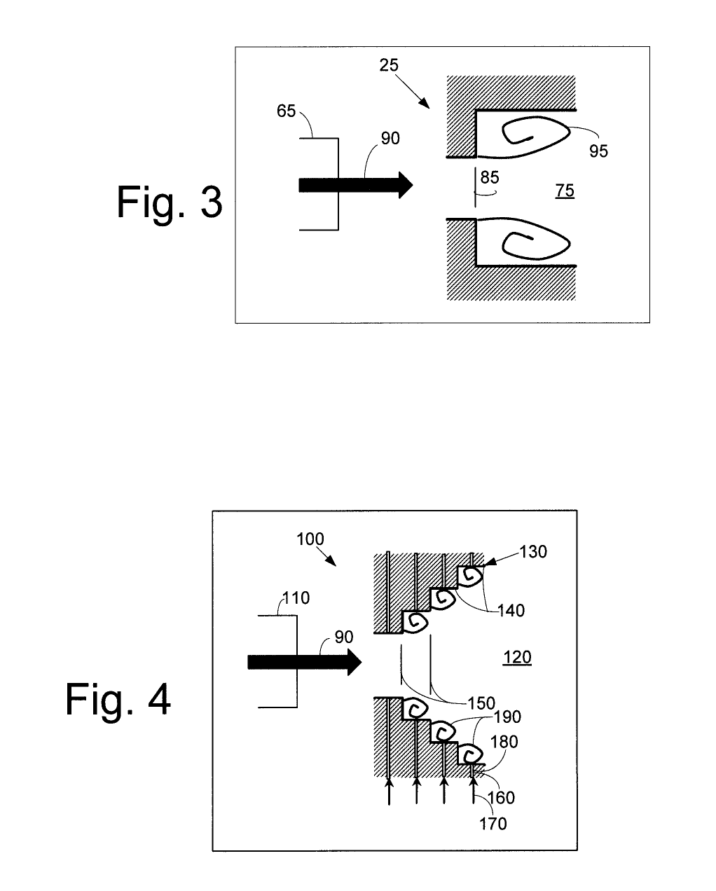

FIG. 3 shows the combustion zone 75 of the combustor 25. The combustion zone 75 may have a substantially uniform, single dump plane 85 downstream of the fuel nozzles 65. A fuel/air mixture 90 thus may pass through the single dump plane 85 and into the combustion zone 75. Depending upon the nature of the combustion instabilities therein, flow structures or vortices 95 may form within the combustion zone 75 so as to impair the operation of the combustor 25. Such vortex driven combustion instabilities may be characterized by the “Strouhal” number. Generally described, the Strouhal number is a dimensionless number relating to oscillating flow mechanisms. The Strouhal number generally may be considered as St=fH/U where f is the frequency of the vortex shedding, H is the height, for example, of the combustion zone 75 in a radial direction, and U is the velocity of the fuel/air mixture 90. Other types of flow descriptions may be used herein. For example, the Rayleigh criterion concerning the phase between heat release and acoustic pressure also may be considered herein.

FIG. 4 is a schematic diagram of a portion of a combustor 100 as may be described herein. The combustor 100 may include a number of fuel nozzles 110. The fuel nozzles 110 may be positioned about the end cap 55 and the like. The combustor 100 also may include a combustion zone 120 downstream of the fuel nozzles 110. In this example, the combustion zone 120 may be a multi-step combustion zone 130. Specifically, the multi-step combustion zone 130 may include a number of steps 140 progressing in a radial direction downstream of the fuel nozzles 110. Any number of the steps 140 may be used herein in any size, shape, or configuration. The height of any given step 140 thus may be a fraction of the height of the combustion zone 75 described above. The height of the steps 140 may be uniform or may vary. The use of the steps 140 thus provides a multi-step dump plane 150 herein. Other components and other configurations may be used herein.

The combustor 100 also may include a number of pilot fuel/air lines 160. The pilot fuel/air lines 160 may be positioned about the combustion zone 120 so as to inject a pilot fuel/air mixture 170 in a largely radial direction 180, i.e., perpendicular to the direction of the fuel/air mixture 90. The number of the pilot fuel/air lines 160 may vary. The size, shape, and configuration of the pilot fuel/air lines 160 also may vary. The nature of the pilot fuel/air mixture 170 may vary. Each step 140 may have one or more of the pilot fuel/air lines 160 therein. Other components and other configurations also may be used herein.

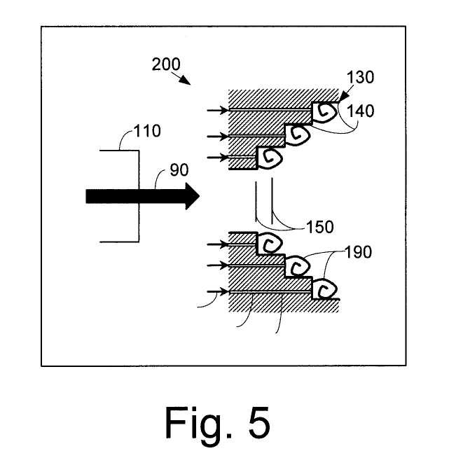

FIG. 5 shows an alternative embodiment of a combustor 200 as may be described herein. As described above, the combustor 200 may include the fuel nozzles 110 leading to the multi-step combustion zone 130 with the steps 140 forming the multi-step dump plane 150. The combustor 200 also may include the pilot fuel/air lines 160 for injecting the pilot fuel/air mixture 170 into the combustion zone 120. In this example, however, the pilot fuel/air lines 160 may be positioned in a largely axial direction 210, i.e., parallel to the direction of the fuel/air mixture 90. Each step 140 may have one or more of the pilot fuel/air lines 160 therein. Other components and other configurations may be used herein.

In use, the multi-step combustion zone 130 may have a direct impact on the length scale of the vortices 190 and the shedding frequencies within the combustion zone 130. In other words, for a given Strouhal number, the reduced height of the steps 140 increases the shedding frequency and hence turbulence so as to minimize vortex driven combustion instabilities therein. For example, the shear layer may be separated from an upstream step so as to impinge on the next downstream step edge and, hence, act as a source of turbulence production. Such increased turbulence may prevent the development of large scale structures in the flow so as to enhance fine scale mixing and flame stability. The use of the steps 140 also has an impact on the time delay in heat release fluctuations and other advantages.

The use of the pilot fuel/air lines 160 about the combustion zone 130 helps in controlling the flow flame-acoustic interaction. Specifically, the pilot fuel/air mixture 170 may have an impact on the local equivalence ratio of the fuel/air mixture 90 at each step 140. The phase between the heat release and the acoustic pressure thus may play a role in feeding the energy into the acoustic nodes. This phase modification may be achieved by altering the equivalence ratio by injecting the pilot fuel/air mixture 170 into the fuel/air mixture 90. The addition of the pilot fuel/air mixture 170 thus changes the heat release distribution therein. The injection of the pilot fuel/air mixture 170 may be adjusted such that the flame does not add energy into the acoustic nodes. Injection of the pilot fuel/air mixture 170 also affects the NOₓ emissions profile. Overall operation of the gas turbine 10 thus may be improved as well as the overall operating life.

The use of the steps 140 may be optimized herein based upon the size of the vortices and the vortex shedding frequency. The pilot fuel/air mixture 170 may be injected in either the radial direction 180 or the axial direction 210 so as to change the overall equivalence ratio. The combustors 100, 200 described herein thus provide both passive control through the use of the multi-step combustion zone 120 as well as active control given the pilot fuel/air lines 160. The combination of the passive and active controls thus may extend the range of stable operating conditions for the combustors 100, 200 herein and the like.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A combustor, comprising:
a plurality of fuel nozzles; and
a combustion zone downstream of the plurality of fuel nozzles;
the combustion zone comprising a plurality of steps such that the combustion zone expands in a radial direction downstream of the plurality of fuel nozzles.

2. The combustor of claim 1, wherein the combustion zone comprises a plurality of pilot fuel/air lines therein.

3. The combustor of claim 2, wherein the plurality of pilot fuel/air lines extends in a radial direction.

4. The combustor of claim 2, wherein the plurality of pilot fuel/air lines extends in an axial direction.

5. The combustor of claim 2, wherein each step of the plurality of steps comprises one or more of the plurality of pilot fuel/air lines.

6. The combustor of claim 2, wherein the plurality of fuel nozzles provide a fuel/air mixture to the combustion zone and wherein the plurality of pilot fuel/air lines provide a pilot fuel/air mixture to the combustion zone.

7. The combustor of claim 6, wherein the pilot fuel/air mixture alters an equivalence ratio of the fuel/air mixture.

8. The combustor of claim 6, wherein changing the pilot fuel/air mixture changes an equivalence ratio of the fuel/air mixture.

9. The combustor of claim 1, wherein the plurality of steps comprises a multi-step dump plane.

10. The combustor of claim 1, wherein the plurality of steps promotes turbulence within the combustion zone.

11. The combustor of claim 1, wherein the plurality of steps limits the formation of one or more vortices within the combustion zone.

12. A method of limiting combustion instabilities in a combustor, comprising:
introducing a fuel/air mixture into a multi-step combustion zone;
introducing a pilot fuel/air mixture into the multi-step combustion zone; and
altering an equivalence ratio of the fuel/air mixture.

13. The method of claim 12, wherein the step of introducing a pilot fuel/air mixture comprises introducing the pilot fuel/air mixture in a radial direction.

14. The method of claim 12, wherein the step of introducing a pilot fuel/air mixture comprises introducing the pilot fuel/air mixture in an axial direction.

15. The method of claim 12, wherein the step of introducing the fuel/air mixture into a multi-step combustion zone comprises limiting the formation of one or more vortices therein.

16. A combustor, comprising:
a plurality of fuel nozzles; and
a combustion zone downstream of the plurality of fuel nozzles;
the combustion zone comprising a plurality of steps such that the combustion zone expands in a radial direction; and
the combustion zone comprising a plurality of pilot fuel/air lines therein.

17. The combustor of claim 16, wherein the plurality of pilot fuel/air lines extends in a radial direction.

18. The combustor of claim 16, wherein the plurality of pilot fuel/air lines extends in an axial direction.

19. The combustor of claim 16, wherein each step of the plurality of steps comprises one or more of the plurality of pilot fuel/air lines.

20. The combustor of claim 16, wherein the plurality of steps comprises a multi-step dump plane.
